(19) United States
(12) Patent Application Publication
(10) Pub. No.: US 2015/0325140 A1
(43) Pub. Date: Nov. 12, 2015

(54) TELECOMMUNICATIONS EQUIPMENT DEMONSTRATION APPARATUS

(71) Applicant: SKL Services Inc., Alvin, TX (US)

(72) Inventors: Trace G. England, Houston, TX (US); Jay Gubert, Hungerford, TX (US)

(21) Appl. No.: 14/703,951

(22) Filed: May 5, 2015

Related U.S. Application Data
(60) Provisional application No. 61/989,777, filed on May 7, 2014.

(51) Int. Cl. G09B 19/00; H04M 7/00

(52) U.S. Cl. CPC G09B 19/00; H04M 7/006

(57) ABSTRACT

The present invention is directed to implementing demonstration of telecommunications equipment. A telecommunications equipment demonstration apparatus configured in accordance with an embodiment of the present invention provides a fast and easy way of demonstrating end-use capabilities and functionalities of the telecommunications equipment to a prospective end-user. Advantageously, such a telecommunications equipment demonstration apparatus allows the telecommunications equipment to be set-up quickly and without complexity and allows the full range of end-use capabilities and functionalities (i.e., communication services) of the telecommunications equipment to be demonstrated in a manner that is simple and representative of real-world use.

### CROSS REFERENCE TO RELATED APPLICATIONS

This patent application claims priority to co-pending U.S. Non-Provisional Patent Application having Ser. No. 61/989,777 filed May 7, 2014 entitled “COMPUTER-IMPLEMENTED METHOD, APPARATUS, AND COMPUTER-READABLE MEDIUM FOR IMPLEMENTING DEMONSTRATION OF A PHONE SYSTEM”, which has a common applicant herewith and is incorporated herein in its entirety by reference.

### FIELD OF THE DISCLOSURE

The disclosures made herein relate generally to telecommunications systems and equipment and, more particularly, to a method, apparatus and computer-readable medium for implementing demonstration of telecommunications equipment such as, for example, a telephone (i.e., phone) system.

### BACKGROUND

There are a variety of factors that can make sales and marketing of telecommunications equipment challenging. These challenges often arise from modern telecommunications equipment such as phone systems, network interface devices and the like having specific set-up requirements as well as a broad range of end-use capabilities and functionalities (i.e., end use features). In some instances, these set-up requirements and end-use features can be a detriment to enabling a particular piece or line of telecommunications equipment to be demonstrated to a prospective customer in a manner that is beneficial to a sales or marketing objective. Therefore, in a demonstration environment, a sales or marketing representative needs to be able to set-up the telecommunications equipment quickly and without complexity and, once set-up, the full range of end-use capabilities and functionalities of the telecommunications equipment needs to be able to be demonstrated in a manner that is simple and representative of real-world use.

### SUMMARY OF THE DISCLOSURE

Embodiments of the present invention are directed to implementing demonstration of telecommunications equipment. More specifically, embodiments of the present invention are directed to a telecommunications equipment demonstration apparatus (e.g., in the form of a kit) that provides a fast and easy way of demonstrating end-use capabilities and functionalities of the telecommunications equipment to a prospective end-user. Advantageously, a telecommunications equipment demonstration apparatus configured in accordance with the present invention allows the telecommunications equipment to be set-up quickly and without complexity and allows the full range of end-use capabilities and functionalities (i.e., communication services) of the telecommunications equipment to be demonstrated in a manner that is simple and representative of real-world use. A phone system such as a Virtual Tone brand phone system with Polycom brand of phones is an example of such telecommunications equipment. Additionally, a telecommunications equipment demonstration apparatus configured in accordance with the present invention can provides full system capabilities with and without Internet service. When attached to the Internet, such a telecommunications equipment demonstration apparatus can make and receive live calls in both inbound and outbound directions.

In an embodiment of the present invention, a phone system demonstration station, comprises a demonstration unit support platform, at least one phone demonstration unit, and demonstration enabling circuitry. The demonstration unit support platform has a top surface and a bottom surface. The at least one phone demonstration unit is engaged with the top surface of the demonstration unit support platform. The demonstration enabling circuitry is secured to the top surface of the demonstration unit support platform, the bottom surface of the demonstration unit support platform, or a combination thereof. The demonstration enabling circuitry is operably coupled to the at least one phone demonstration unit. The demonstration enabling circuitry is configured for providing demonstration enabling functionality thereof to the at least one phone demonstration unit when the demonstration enabling circuitry is provided with electrical power and a communication network connection.

In another embodiment of the present invention, a telecommunication equipment demonstration apparatus comprises an equipment enclosure, a telecommunication equipment demonstration unit, and demonstration enabling circuitry. The equipment enclosure has a cavity therein. The telecommunication equipment demonstration unit is exposed within an opening of the equipment enclosure defined by the cavity thereof. The demonstration enabling circuitry is provided within an interior space of the equipment enclosure. The demonstration enabling circuitry is operably coupled to the telecommunication equipment demonstration unit and wherein the demonstration enabling circuitry implements functionality for enabling the demonstration enabling circuitry to provide demonstration enabling functionality thereof when the demonstration enabling circuitry is provided with electrical power and connection to an Internet connection.

In another embodiment of the present invention, a method of demonstrating telecommunication equipment comprising a plurality of operations. An operation of providing a phone system demonstration station is performed. The phone system demonstration station includes a demonstration unit support platform within a platform receiving cavity of the manually portable enclosure, a phone demonstration unit engaged with the demonstration unit support platform such that the phone demonstration unit is access through an opening of the manually portable enclosure defined by the platform receiving cavity thereof, and demonstration enabling circuitry within the platform receiving cavity of the manually portable enclosure at a location between the demonstration unit support platform and a closed end portion of the platform receiving cavity. The demonstration enabling circuitry is operably coupled to the phone system demonstration unit. An operation of providing the demonstration enabling circuitry with a network connection is performed for enabling the phone system demonstration unit to perform demonstration enabling functionality thereof using network connectively provided by the network connection. An operation of implementing native communication operations of the phone system demonstration unit utilizing the demonstration enabling functionality provided of the demonstration enabling circuitry is performed.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative side view showing a phone system demonstration station configured in accordance with an embodiment of the present invention.

FIG. 2 is an illustrative plan view of the phone system demonstration station shown in FIG. 1.

FIG. 3 is a cross-sectional view showing a demonstration apparatus configured in accordance with an embodiment of the present invention.

### DETAILED DESCRIPTION

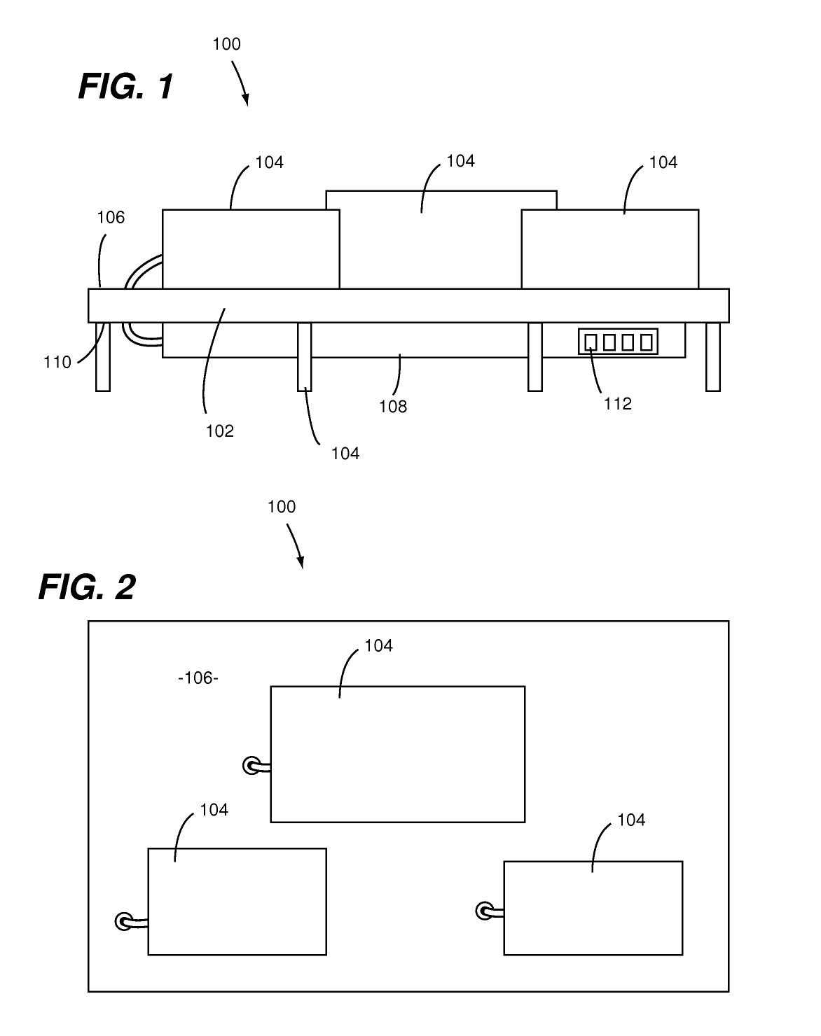

FIGS. 1 and 2 show a phone system demonstration station 100 configured in accordance with an embodiment of the present invention. The phone system demonstration station 100 includes a demonstration unit support platform 102, a plurality of phone system demonstration units 104 secured to a top surface 106 of the demonstration unit support platform 102, and phone system operating components 108 secured to a bottom surface 110 of the demonstration unit support platform 102. Alternatively, the phone system operating components 108 can be engaged with the top surface 106 or to both the top and bottom surfaces 106, 110 of the demonstration unit support platform 102. The platform 102 can be made using any suitable materials/construction and can include a suitable support structure such as, for example, a plurality of legs 114.

It is disclosed herein that, in some embodiments, one or more of the phone system demonstration units 104 are secured to the demonstration unit support platform 102 in a manner such that they are selectively detachable from and attachable to the top surface 106 of the demonstration unit support platform 102. For example, one or more of the phone system demonstration units 104 can be desktop units that are fixedly secured to the top surface 106 of the demonstration unit support platform 102 and one or more of the phone system demonstration units 104 can be handheld/mobile units that are selectively detachable from and attachable to the top surface 106 of the demonstration unit support platform 102.

Voice over Internet Protocol (VOIP) phone units such as those offered by Polycom are examples of the phone system demonstration units 104. Furthermore, the phone system demonstration units 104 are one example of telecommunications equipment. It is disclosed herein that embodiments of the present invention can be configured to demonstrate telecommunications equipment other than that of a phone system.

The phone system demonstration units 104 are operably connected to the phone system operating components 108. The phone system operating components 108 include service interfaces 112 that are configured for being connected to services such as, for example, line power, a POTS (i.e., plain old telephone service (i.e., landline service)) line, the Internet (i.e., a public computer network system) and the like for enabling fully functional actual and/or simulated operation of the phone system demonstration units 104. The phone system operating components 108 is configured for providing demonstration enabling functionality thereof to the phone system demonstration units 104 when the phone system operating components 108 are provided with electrical power and a communication connection.

In the case of the phone system demonstration units 104 operating over a computer network (e.g., a VOIP phone system), an Internet connection is a suitable type of communication connection (i.e., a communication network connection) for enabling demonstration enabling functionality of the phone system operating components 108 to be implemented. It is disclosed herein that the communication connection can be provided in a wired and/or wireless manner. In view of the disclosures made herein, a skilled person will appreciate that the phone system operating components 108 is collectively an example of demonstration enabling circuitry configured in accordance with an embodiment of the present invention.

It is disclosed herein that the demonstration enabling functionality enables the at least one phone demonstration unit to perform end-use communication services thereof. For a VOIP phone system or other suitably configured type of telecommunications equipment, examples of such end-use communication services include, but are not limited to, the functionalities listed in Table 1 below. In view of the disclosures made herein, a skilled person will contemplate other end-use communication services that can be implemented via demonstration enabling functionality and demonstration enabling circuitry suitably configured for providing such demonstration enabling functionality.

TABLE 1
End-Use Communication Services

| Type of | |
|---|---|
| Service | Functionalities |
| Call Queues | Invisible Queues |
| | Remote Queue Members |
| | In Queue Music or Messaging |
| | Queue Experience |
| | Caller Experience |
| | Music on Hold Per |
| | Queue |
| | Queue Announcements |
| | Login Queue Members |
| | Permanent Queue Members |
| IVR | Ringing Options |
| | IVR Courtesy |
| | Alter Caller ID |
| | Extension Dialing |
| | Record Digits |
| | Play Sound |
| | Say Digits/Letters |
| | Get Extension Type |
| | Say a Number |
| | Check User Password |
| | Go to Another IVR Menu |
| | Say Date/Time |
| | Play Sound From URL |
| | Record Sound |
| | Time Based Clause |
| | Send to External Number |
| | Merge Sounds |
| | Change Language |
| | Perform Math |
| | Set Distinctive Ring Hint |
| | Concatenate Variables |
| | Send Call Values to a URL |
| | Dial Extension |
| | Set & Get Global Variable |
| | Send an Email |
| | Store a Recorded Sound in Sound |
| | Manager |
| | Gate Keeper |
| | Get Extension Status |
| | Play Recorded Sound |
| | Upload Recorded Sound |
| | Conditional Clause |
| | Send to Voicemail |
| | Send a Recorded Sound to |
| | Voicemail |
| Third Party | Mobile SIP Apps Click to Call |
| Integration | Integration with Microsoft Office |
| | Firefox Integration |
| | ConnectWise Integration |
| | Salesforce |
| | Microsoft Dynamics CRM |
| | NetSuite |
| | Appointment Reminder Module |
| | Web Call Back Module |
| | Dialer Module |
| Mobility | Acknowledge Call |
| | Converged Phones |
| | InCall Menu |
| | One Mailbox, Many Phones |
| | Send to Voicemail Action |
| | Ring All Action |
| | Same Caller ID, Different Phone |
| | Forward Calls |
| | Cascade Calls Action |
| Extension | 3 to 6 Digit Extensions |
| Management | Extension Groups |
| | Permissions Per |
| | Extension |
| | Bulk Import for Extensions |
| PBX Tools | Multiple Administrators Flexible |
| | Incoming Call Routes |
| | Flexible Outgoing Call Routes |
| | Connection Status View |
| | SNMP Monitoring |
| | Music on Hold in MP3 |
| | Automated Call Recording |
| | Server Info & Disk Usage |
| | Custom Company Directories |
| | Diskspace Quotas for Mailboxes |
| | Custom Time Frames |
| | Music on Hold Announcements |
| | Custom Sound Manager |
| | Outgoing Caller ID Control |
| | Ordered Call Rules |
| Technology | External VOIP Providers |
| Choices | External Trunking |
| | IP or Analog Phones |
| | Video Calling |
| | Special Codec Support |
| | Failover Options Outgoing Calls |
| Notifications | Fax Notifications |
| | Custom Voicemail Notifications |
| | IMAP Mailbox |
| Call Control | Transfers |
| | Call Pickup |
| | Do Not Disturb |
| | Hold |
| | Call Parking |
| | Intercom & Paging |
| Networking | Managed Tech Support Access |
| | Network Access Control |
| | Automatic IP Blocking |
| | Strong Passwords |
| | Easy Network Setup |
| Voicemail | Custom Greetings |
| | Flexible Voicemail Access |
| | Voicemail Blast Groups |
| | Automatic Voicemail Setup |
| | Voicemail Control |
| | 0 Out of Voicemail |
| | External Voicemail |
| Maintenance | Automated Software Updates |
| | Error Logs |
| | Automated Backups |
| | Managed Hardware Upgrades |
| Reporting | Queue Reports |
| | Call Logs |
| | Scheduled Reports |
| | Queue Logs |
| | Call Reports |
| | Queue Status |
| | Concurrent Calls Report |
| Conferencing | Conference Via Handset |
| | Meet Me Conference Center |
| | Simple Conference Room |
| Globalization | Manage Sounds Multiple |
| | Languages |
| | Flexible Language Support |
| | Language Sound Packs |
| | Flexible Date Formats |
| Faxing | Incoming Faxes |
| | Fax to Email |
| | One Number for Voice & Fax |
| Operator | Queue Visualization |
| Panel | Realtime Extension Status |
| | Voicemail Management |
| | Call History |
| | Extension Feature Controls |
| | Multiple Extensions |

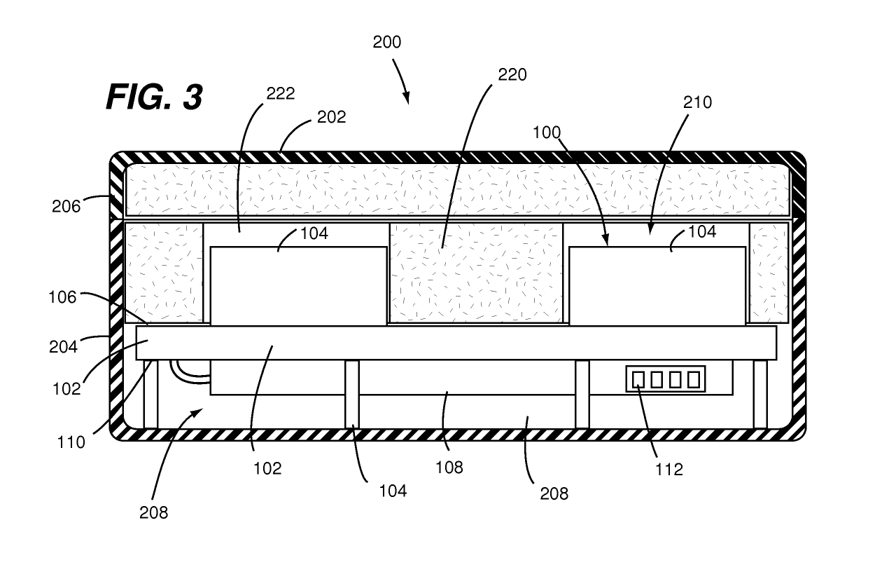

Referring now to FIG. 3, a demonstration apparatus 200 (i.e., a phone system demonstration kit) configured in accordance with an embodiment of the present invention is shown. The demonstration apparatus 200 includes a carrying case 202 (i.e., a equipment enclosure) and the phone system demonstration station 100. The carrying case 202 includes a carrying case base 204 and a carrying case lid 206 moveably mounted on the carrying case base 204 for allowing the carrying case lid 206 to be moved to an orientation with respect to the carrying case base 204 for allowing access to a cavity 208 of the carrying case base 204. Preferably, but not necessarily, the carrying case lid 206 is pivotably attached to the carrying case base 204 such as though one or more hinges. Alternatively, the carrying case lid 206 can be configured for being entirely detached from the carrying case base 204. The phone system demonstration station 100 is located (e.g., fixedly or removably) within the cavity 208 of the carrying case base 204. In this respect, the cavity 208 is a demonstration unit support platform receiving cavity. The phone system demonstration units 104 of the phone system demonstration station 100 are exposed within an opening 210 of the carrying case base 204. The opening 210 is defined by an open end portion the cavity 208. In this respect, particularly when the phone system demonstration station 100 is fixedly located within the cavity 208 of the carrying case base 204, the portion of the phone system operating components 108 that are attached to the bottom surface 110 of the demonstration unit support platform 102 are located within an interior space of the carrying case 202 (i.e., a space jointly defined by the demonstration unit support platform 102 and the cavity 208 of the carrying case base 204.

The demonstration apparatus 200 includes a phone demonstration unit protection insert 220. In one embodiment, the phone demonstration unit protection insert 220 is a protective foam insert. The phone demonstration unit protection insert 220 is positioned within the cavity 208 of the carrying case base 204 above the phone system demonstration station 100. Each one of the phone demonstration units 104 of the phone system demonstration station 100 is located within a respective phone demonstration unit receiving space 222 of the phone demonstration unit protection insert 220. In this respect, the phone demonstration unit protection insert 220 supports and protects the phone demonstration units 104 during transport of the demonstration apparatus 200.

Turing now to a method of use of the demonstration apparatus 200, a set of steps for demonstrating a phone system is presented. After moving the carrying case lid 206 from its closed position (FIG. 3) to its open position (FIG. 4), the phone demonstration unit protection insert 220 is removed from within the cavity 208 of the carrying case base 204. After removing the phone demonstration unit protection insert 220 from the cavity 208 of the carrying case base 204, the phone system demonstration station 100 is removed from within the cavity 208 of the carrying case base 204. In a first embodiment of the method (i.e., table top use with the phone system demonstration station 100 is removed from within the cavity 208 of the carrying case base 204), electrical power and one or more suitable communication connections are provided to the phone system operating components 108 after removal of the phone system demonstration station 100 is removed from within the cavity 208 of the carrying case base 204 thereby allowing demonstration of the phone demonstration units 104 to be implemented. Electrical power can be provided via a power supply cable of the phone system operating components 108 being plugged into a power source and one or more suitable communication connection can be provided via an active Ethernet cable being plugged into a network connector of the phone system operating components 108 to provide network (e.g., Internet) connectivity.

In a second embodiment of the method (i.e., the phone system demonstration station 100 used while in the cavity 208 of the carrying case base 204), the phone demonstration unit protection insert 220 is placed back into the cavity 208 of the carrying case base 204 after the phone demonstration unit protection insert 220 is removed from the cavity 208 of the carrying case base 204. Thereafter, the phone system demonstration station 100 is placed back into the cavity 208 of the carrying case base 204 on top of the phone demonstration unit protection insert 220. In this respect, the phone demonstration unit protection insert 220 serves as a stand-off for the phone system demonstration station 100 to maintain it at an elevated position within the cavity 208 of the carrying case base 204. Electrical power and one or more suitable communication connection are provided to the phone system operating components 108 after the phone system demonstration station 100 is placed back into the cavity 208 of the carrying case base 204 thereby allowing demonstration of the phone demonstration units 104 to be implemented. Electrical power can be provided via a power supply cable of the phone system operating components 108 being plugged into a power source and one or more suitable communication connection can be provided via an active Ethernet cable being plugged into a network connector of the phone system operating components 108 to provide network (e.g., Internet) connectivity.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A phone system demonstration station, comprising:
a demonstration unit support platform having a top surface and a bottom surface;
at least one phone demonstration unit engaged with at least one of the top surface and the bottom surface of the demonstration unit support platform; and
demonstration enabling circuitry engaged with at least one of the top surface and the bottom surface of the demonstration unit support platform, wherein the demonstration enabling circuitry is operably coupled to the at least one phone demonstration unit and wherein the demonstration enabling circuitry is configured for providing demonstration enabling functionality thereof to the at least one phone demonstration unit when the demonstration enabling circuitry is provided with electrical power and a communication network connection.

2. The phone system demonstration station of claim 1 wherein the at least one phone demonstration unit being engaged with the top surface of the demonstration unit support platform includes a plurality of phone demonstration units.

3. The phone system demonstration station of claim 2 wherein each one of the phone demonstration units is selectively detachable from and attachable to the top surface of the demonstration unit support platform.

4. The phone system demonstration station of claim 1 wherein the demonstration enabling functionality enables the at least one phone demonstration unit to perform end-use communication services thereof.

5. The phone system demonstration station of claim 4 wherein:
the at least one phone demonstration unit being engaged with the top surface of the demonstration unit support platform includes a plurality of phone demonstration units; and
each one of the phone demonstration units is selectively detachable from and attachable to the top surface of the demonstration unit support platform.

6. The phone system demonstration station of claim 5 wherein each one of the phone demonstration units is a Voice Over Internet Protocol (VOIP) phone.

7. The phone system demonstration station of claim 1, further comprising:
a demonstration unit support platform carrying case, wherein the demonstration unit support platform is removably located within a platform receiving cavity of the demonstration unit support platform carrying case.

8. The phone system demonstration station of claim 7 wherein the demonstration enabling circuitry is secured to the bottom surface of the demonstration unit support platform such that the demonstration enabling circuitry is contained within an interior space defined by the cavity of the demonstration unit support platform carrying case and the demonstration unit support platform.

9. The phone system demonstration station of claim 8 wherein the demonstration enabling functionality enables the at least one phone demonstration unit to perform end-use communication services thereof.

10. The phone system demonstration station of claim 9 wherein:
the at least one phone demonstration unit being engaged with the top surface of the demonstration unit support platform includes a plurality of phone demonstration units; and
each one of the phone demonstration units is selectively detachable from and attachable to the top surface of the demonstration unit support platform.

11. A telecommunication equipment demonstration apparatus, comprising:
an equipment enclosure having a cavity therein;
a telecommunication equipment demonstration unit exposed within an opening of the equipment enclosure defined by the cavity thereof; and
demonstration enabling circuitry within an interior space of the equipment enclosure, wherein the demonstration enabling circuitry is operably coupled to the telecommunication equipment demonstration unit and wherein the demonstration enabling circuitry implements functionality for enabling the demonstration enabling circuitry to provide demonstration enabling functionality thereof when the demonstration enabling circuitry is provided with electrical power and connection to an Internet connection.

12. The telecommunication equipment demonstration apparatus of claim 11 wherein
the telecommunication equipment demonstration unit is selectively detachable from and attachable to a top surface of a demonstration unit support platform; and
the demonstration unit support platform is removably located within a platform receiving cavity of the demonstration unit support platform carrying case.

13. The telecommunication equipment demonstration apparatus of claim 11 wherein the telecommunication equipment demonstration unit is a Voice Over Internet Protocol (VOIP) phone.

14. The telecommunication equipment demonstration apparatus of claim 11 wherein the demonstration enabling functionality enables the telecommunication equipment demonstration unit to perform end-use communication services thereof.

15. The telecommunication equipment demonstration apparatus of claim 14 wherein the telecommunication equipment demonstration unit is a Voice Over Internet Protocol (VOIP) phone.

16. The telecommunication equipment demonstration apparatus of claim 11 wherein
the telecommunication equipment demonstration unit is selectively detachable from and attachable to a top surface of a demonstration unit support platform; and
the demonstration unit support platform is removably located within a platform receiving cavity of the demonstration unit support platform carrying case.

17. The telecommunication equipment demonstration apparatus of claim 16 wherein:
the demonstration enabling functionality enables the telecommunication equipment demonstration unit to perform end-use communication services thereof; and
the telecommunication equipment demonstration unit is a Voice Over Internet Protocol (VOIP) phone.

18. A method of demonstrating telecommunication equipment, comprising:
providing a phone system demonstration station including a manually portable enclosure having a demonstration unit support platform within a platform receiving cavity of the manually portable enclosure, a phone demonstration unit engaged with the demonstration unit support platform such that the phone demonstration unit is access through an opening of the manually portable enclosure defined by the platform receiving cavity thereof, and demonstration enabling circuitry within the platform receiving cavity of the manually portable enclosure at a location between the demonstration unit support platform and a closed end portion of the platform receiving cavity, wherein the demonstration enabling circuitry is operably coupled to the phone demonstration unit;
providing the demonstration enabling circuitry with a network connection for enabling the phone demonstration unit to perform demonstration enabling functionality thereof using network connectively provided by the network connection; and
implementing end-use communication services of the phone demonstration unit utilizing the demonstration enabling functionality provided of the demonstration enabling circuitry.

19. The method of claim 18:
wherein the phone demonstration unit is secured to a top surface of the demonstration unit support platform;
wherein the phone system demonstration station includes a phone demonstration unit protection insert within the platform receiving cavity of the manually portable enclosure;
wherein the phone demonstration unit is located within a phone demonstration unit receiving space of the phone demonstration unit protection insert;
further comprising removing the demonstration unit support platform from within the platform receiving cavity;
further comprising placing the phone demonstration unit protection insert within the platform receiving cavity; and
further comprising placing the demonstration unit support platform on the phone demonstration unit protection insert such that the phone demonstration unit protection insert serves to retain the demonstration unit support platform in an elevated position within the platform receiving cavity for allowing access to the phone demonstration unit.

20. The method of claim 18, further comprising:
removing the demonstration unit support platform from within the platform receiving cavity;
wherein the phone demonstration unit is secured to a top surface of the demonstration unit support platform;
wherein the demonstration enabling circuitry is secured to a bottom surface of the demonstration unit support platform; and
wherein providing the demonstration enabling circuitry with the network connection includes connecting a cable to the demonstration enabling circuitry after removing the demonstration unit support platform from within the platform receiving cavity
